(19) United States
(12) Patent Application Publication
(10) Pub. No.: US 2009/0148073 A1
(43) Pub. Date: Jun. 11, 2009

(54) ALLOWING USERS TO AUTOMATICALLY CHANGE TYPOGRAPHICAL LETTER CASE USING APPLICATION INDEPENDENT FUNCTIONALITY

(75) Inventors: JANA H. JENKINS, RALEIGH, NC (US); WILLIAM D. PETERSON, Jr., MYRTLE BEACH, SC (US)

Correspondence Address: PATENTS ON DEMAND, P.A. IBM-RSW, 4581 WESTON ROAD, SUITE 345, WESTON, FL, 33331, US

(73) Assignee: INTERNATIONAL BUSINESS MACHINES CORPORATION, ARMONK, NY (US)

(21) Appl. No.: 11/952,776

(22) Filed: Dec. 7, 2007

(51) Int. Cl. G06K 9/03

(52) U.S. Cl. 382/311

(57) ABSTRACT

The present invention discloses a solution for allowing users to manipulate typographical letter case. In the solution, functionality can be implemented that allows users to quickly select a set of letters and to manipulate letter case of the selected text in a variety of ways. For example, an existing case of a selection can be changed to uppercase, lowercase, title case, sentence case, and the like. Additionally, functionality can enable users to invert letter case and randomize letter case as needed. Further, letter case checking functionality can detect words in a document having possibly improper case, can provide prompts containing suggested corrections, and can provide options to apply or ignore the suggested corrections.

### BACKGROUND

1. Field of the Invention

The present invention relates to the field of software productivity tools and, more particularly, to allowing users to automatically change typographical letter case using application independent functionality.

2. Description of the Related Art

A common problem with touch typing using computer keyboards is many users inadvertently strike the caps lock key when attempting to tap the shift key. This is due mainly in part to the positioning of these two keys on keyboards. The caps lock key, located above the shift key, changes lowercase letters into uppercase letters. Once activated, letter case is inverted until the user hits the caps lock key again to disable this functionality. With the caps lock enabled, when the user attempts to capitalize, upper case is inverted to lower case and vice versa. For example, the word “Hello” becomes “hELLO” with the caps lock key engaged. While there are typically visual indicators on keyboards to notify a user that the caps lock is on, many users, especially touch typists, never see this visual indicator.

Fixing improper case errors can be extremely time consuming and negatively impacts productivity. In addition, many users may not be aware of the appropriate letter case for given words and thus not capable to make necessary changes. It would be advantageous if a solution were devised to combat the loss of productivity incurred by this common problem.

### SUMMARY OF THE INVENTION

The present invention discloses a solution for allowing users to automatically change typographical letter case using application independent functionality. In the solution, functionality can exist that allows users to quickly manipulate letter case of text in a variety of ways. Users can be able to select displayed text within a GUI and to change the selected text's letter case to uppercase, lowercase, toggle case, title case, and/or sentence case as desired. Additionally, functionality can enable users to invert letter case and randomize letter case as needed. Further, letter case checking functionality can determine when letter case is not appropriate and prompt the user with suggested fixes.

The present invention can be implemented in accordance with numerous aspects consistent with the materials presented herein. One aspect of the present invention can include software for providing case manipulation enhancements that includes a case converter configured to identify user selected text, to receive a user selected case command, and to apply the case command to the user selected text, which results in the selected text being replaced with replacement text. The replacement text can correspond to the user selected text that has been case changed in accordance with the case command. Case commands can include an upper case command, a lower case command, and a toggle case command, a sentence case command, a title case command, and/or a random case command. The software can also include a case analyzer configured to apply a set of programmatic rules to a text segment, to automatically determine from the set of rules whether letters included in the text segment have a proper case, and to present results from applying the set of rules to a user. The results can indicate those letters that are determined to have an improper case.

Another aspect of the present invention can include an interactive method for altering case of a text segment. The method can receive a user selection of a text segment within a user interface, which can be a Graphical User Interface (GUI), a Voice User Interface (VUI), or a multimodal interface. A user input can be received via the user interface that indicates a case command to be performed against the text segment. The case command can be applied to the text segment to change the text segment in accordance with the case command. The changed text segment can be presented to a user via the user interface.

Still another aspect of the present invention can include a method for conducting a case check. In the method, a user command to analyze at least a portion of an electronic document for case related errors can be through a user interface. Responsive to the command, a set of programmatic rules to the portion of the electronic document. An automatic determination can be made from the set of rules as to whether letters included in the portion of the electronic document have a proper case. Results from applying the set of rules can be presented within the user interface. The results can indicate those letters that are determined to have an improper case.

Still another aspect of the present invention can include a method for conducting a case check. In the method, a user command to analyze at least a portion of an electronic document for case related errors can be through a user interface. Responsive to the command, a set of programmatic rules are applied to the portion of the electronic document, or to the entire document. An automatic determination can be made from the set of rules as to whether letters included in the portion of the electronic document, or to the entire document, have a proper case. Results from applying the set of rules can be presented within the user interface. The results can indicate those letters that are determined to have an improper case.

It should be noted that various aspects of the invention can be implemented as a program for controlling computing equipment to implement the functions described herein, or as a program for enabling computing equipment to perform processes corresponding to the steps disclosed herein. This program may be provided by storing the program in a magnetic disk, an optical disk, a semiconductor memory or any other recording medium. The program can also be provided as a digitally encoded signal conveyed via a carrier wave. The described program can be a single program or can be implemented as multiple subprograms, each of which interact within a single computing device or interact in a distributed fashion across a network space.

### BRIEF DESCRIPTION OF THE DRAWINGS

There are shown in the drawings, embodiments which are presently preferred, it being understood, however, that the invention is not limited to the precise arrangements and instrumentalities shown.

FIG. 1 is a schematic diagram illustrating a system for automatically modifying the letter case of highlighted text in response to user selection accordance with an embodiment of the inventive arrangements disclosed herein.

FIG. 2 is a schematic diagram illustrating a graphical user interface (GUI) for performing a case check on an electronic document in accordance with an embodiment of the inventive arrangements disclosed herein.

FIG. 3 is a schematic diagram illustrating a method for enabling a user to change the letter case of highlighted text in accordance with an embodiment of the inventive arrangements disclosed herein.

FIG. 4 is a schematic diagram illustrating a method for checking the letter case of electronic document content in response to a user invocation in accordance with an embodiment of the inventive arrangements disclosed herein.

### DETAILED DESCRIPTION OF THE INVENTION

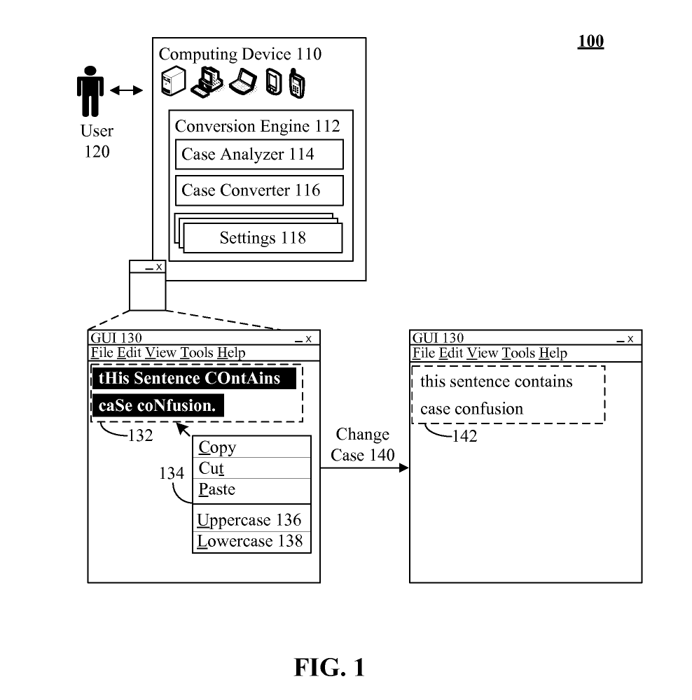

FIG. 1 is a schematic diagram illustrating a system 100 for automatically modifying the letter case of highlighted text in response to user selection in accordance with an embodiment of the inventive arrangements disclosed herein. In system 100, a user 120 interacting with a computing device 110 can rapidly modify the letter case of highlighted text 132. For instance, in GUI 130, a user 120 selecting menu entry 138 from pop-up menu 134 can automatically change the case of highlighted mixed-case text 132 to lowercase, which results in a case change 140 shown in segment 142. Other case changing options can be provided, such as an upper case option 136, a title case option, a sentence case option, an invert case option, a random case option, and the like.

The computing device 110 can include a check case capability, which automatically checks for case related problems within a selected electronic document and that optionally prompts users with correction suggestions. The check case capability can be an additional user selectable capability similar in implementation to a conventional spell checking capability. For example, an auto detection capability can be implemented, which automatically underlines text believed to have case problems and that provides corrective suggestions upon right mouse clicking the underlined text. In one embodiment, the check case capability can be an enhancement to an executing “check” capability, which is automatically invoked when a document is checked for spelling and/or grammar.

The case change and case checking functions can be implemented by a conversion engine 112 of the computing device 110 in accordance with user configurable settings 118. The conversion engine 112 can be a component/feature of a specific application and/or can be a component/feature implemented for a set of two or more applications (e.g., an office suite). Further, the conversion engine 112 although operating against text presented upon device 110 can be implemented in a variety of manners, such as being implemented as a terminate and stay resident (TSR) application of device 110, implemented within code of an application executing on device 110, implemented for an application executed by a remote application server that is provided to device 110, implemented for a Web application rendered within a Web browser of device 110, implemented as a Web service available to device 110, and the like. There are no constraints on a type of application for which the case change and case checking functionality can be applied other than an ability to edit text. For example, the case related enhancements can be applied to text editors, word processors, spreadsheets, presentation applications, database front-ends, browsers, email programs, chat programs, text related macros, text manipulation scripts, etc.

As shown, conversion engine 112 can be a software component capable of identifying and modifying the letter case of text. Conversion engine 112 can reside and execute in a computing device 110 or can be distributed across a network infrastructure. Conversion engine 112 can comprise of case analyzer 114, case converter 116 and settings 118.

Case analyzer 114 can be capable of inspecting and determining an appropriate letter case for a word or set of words. Inspection can occur automatically or be manually invoked by the user 120. For example, as user 120 types analyzer 114 can check each word or words for correct letter case usage. Based on grammatical rules and/or context rules word/words can be determined to have appropriate letter case or contain letter case errors. In one embodiment, the configurable settings 118 can change which rules are applied when performing case checking actions. User 120 can be notified instantly of letter case errors when inspection occurs automatically. Notification of unsuitable letter case can be achieved in GUI 130 through underling, highlighting, and the like. Manual examination of text can be achieved through menu 134 entries 136,138.

Case converter 116 can be a software component able to modify a text selection from one letter case to another letter case. Converter 116 can include functionality to modify text to lowercase, uppercase, sentence case, title case, invert case, random case, and the like. Conversion of text can occur based on a programmatic algorithm which can include manipulation based on single character, single word, groups of words, sentences and the like. In situations where converter 116 cannot modify text (e.g. Web pages), a converted version of the text can be stored in the system and/or application copy/paste buffer for future use.

Settings 118 can be a set of preferences and rules for governing the behavior of conversion engine 112. Preferences can include user programmable key bindings, language settings, and the like. Key bindings can be application specific or system-wide allowing invocation of engine 112 based on user specified bindings. Further, settings 118 can control the presentation of case options, such as presenting case options in context menus, drop-down menus, toolbars, and the like. Settings 118 can include a set of grammatical rules for determining the appropriate letter case for words or groups of words. Additionally, context rules for determining appropriate letter case for word/words can be contained in settings 118. These grammatical and contextual rules can be heuristically determined and modified based on user 120 history and behavior. In one embodiment, a library (e.g., user established dictionary) can contain a set of user established phrases/words for case checking purposes. The library can cause the engine 112 to accept as valid, user-specific phrases that would otherwise contain suspect case combinations.

Computing device 110 can include a hardware/software entity capable of performing computing tasks in response to user interactions. Device 110 can allow a user to perform word processing and/or text manipulation activities and to automatically assist in corrections with letter case inaccuracies. Device 110 can include, but is not limited to, desktop computers, laptops, mobile phones, portable digital assistants (PDAs), multimedia players, and the like.

As defined herein, lower case text can include text containing no majuscule letters and conversely upper case text can include text containing no miniscule letters. Title case can include text which contains all majuscule letters or having a majuscule letter at the beginning of each word. A sentence case option can ensure a first letter of a sentence is a majuscule letter and that other letters of the sentence are in miniscule letters unless grammar rules or exceptions indicate otherwise. Inverted letter case can be reached by changing majuscule letter case to miniscule letter case and miniscule letter case to majuscule letter case. Random case can be achieved through a programmatic algorithm capable of randomly selecting a letter case and replacing selected letter case with current letter case.

Additionally, case corrections/changes of system 100 can apply to situations where a “lower case” version of a key press is changed to an “upper case” version of the same key press. For example, a set of numbers (e.g., 1, 2, 3, 4, 5, 6, 7, 8, 9, and 0) appearing on a typical keyboard change to a set of symbols (!, @, #, $, %, ̂, &, *, (, )) when a shift key is pressed before selecting the related key. This is true, even though pressing the keys when a “caps lock” is enabled, still results in a lower case version of the key press (e.g., 1, 2, 3, 4, 5, 6, 7, 8, 9, and 0). Overloaded keys can vary by keyboard arrangement and implementation, which can be taken into account by the conversion engine 112. Further, a shift and caps lock key are not the only keys capable of changing what representations appear when a key is pressed, but instead some devices 110 have input peripherals that permit multiple modes to be enabled that further overload key presses. The conversion engine 112 can optionally consider these modes and related symbols to be an additional “upper case” version of a key press, which can be converted and/or checked by conversion engine. User configurable settings 118 can establish whether engine 112 is to consider “overloaded” keys as upper and lower case or whether only true upper and lower case letters are to be considered when applying case changing/case detection features.

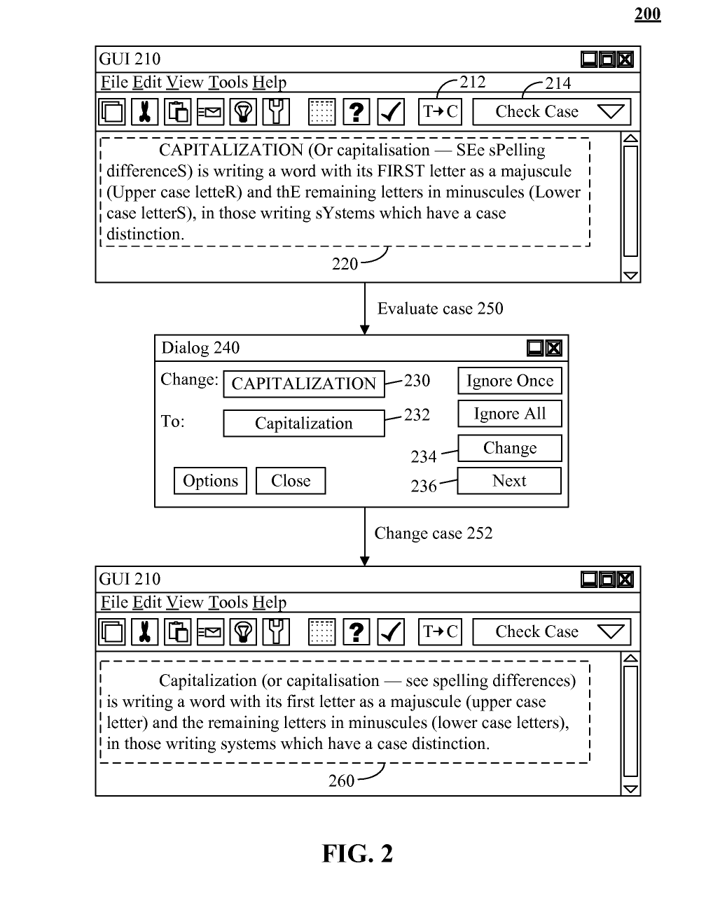

FIG. 2 is a schematic diagram illustrating a graphical user interface (GUI) 200 for performing a case check on an electronic document in accordance with an embodiment of the inventive arrangements disclosed herein. GUI 200 can be performed in the context of system 100. In GUI 200, a user can check the case of an electronic document 220 and automatically perform typographical letter case corrections as necessary. GUI 210 can include case checking and modifying functionality accessible from toolbar entities 212 and 214. Selecting check case from drop down menu 214 can trigger a case checking algorithm for electronic document 220. Case checking functionality can include, evaluating case 250, identifying possible case errors 230, and changing case 252 based on user interaction.

When check case functionality is activated by the user, the document 220 can be examined. If a user highlighted section of text exists when the check case functionality is activated, the highlighted text can be examined. Case checking can occur in an interactive fashion alerting the user of each suggested change. Alternatively, case checking can occur automatically performing changes without user interaction. Once invoked, a case checking algorithm can perform case evaluation 250 on a word, group of words, or sentence. Common typographical case errors can be detected such as lower cased proper nouns, acronyms, title case phrases, and sentences beginning with lower case letters. Further, grammatical rules can be used to determine when lower case, upper case, and mixed case word or words are inappropriate.

Case checking functionality can begin inspecting the document 220 from the start of the document 220, which can be the first word, set of words, or sentence. Alternatively, case checking functionality can begin from the current position of the cursor and continue to the end of the document 220. Based on grammatical rules and context usage rules letter case can be determined to be appropriate or unsuitable. When a letter case suggestion is found, dialog 240 can present the user with options for correcting or ignoring letter case anomalies. For example, dialog 240 can include the presentation of the examined word 230, the suggested replacement 232 and interactive buttons for assisting in the change case 252 process. By selecting change 234 button, the user can perform substitutions on selection 230. These changes can be reflected in updated document 260. Optionally, the user can choose to ignore suggestions by selecting the next 236 button. Once a user has chosen an action, the document 220 can continue to be checked for letter case inconsistencies. When another inconsistency is found in document 220, entity 230 can be updated to present the newly examined word or words. New suggestions for 230 can be presented in field 232. The process can be repeated until the end of document is reached or there are no more letter case suggestions.

Drop-down menu 214 can include options for quickly changing the letter case of selected text. Menu 214 can include options for lowercase, uppercase, title case, sentence case, invert case, and random case. Presenting similar functionality, toolbar entity 212 can allow the user to quickly toggle between different letter cases for any selected text. For example, selecting entity 212 once can toggle selected text to lowercase and selecting a second time can change selected text to upper case, a third time can change the text to title case, and so on. By continually clicking on toolbar entry 212, the user can cycle through letter case options similar to drop-down entity 214.

GUI 210 is for illustrative purposes only and should not be construed to limit the invention in any regard. Functionality expressed in entities 212, 214 can be presented in drop-down menus, context menus, key bindings (e.g., hotkey combinations), GUI ribbons, and the like. Further, functions expressed for GUI 200 can be implemented for non-visual modalities, such as a speech modality (e.g., implemented for a voice user interface (VUI) instead of a GUI). Further, the illustrated implementation arrangements represent one contemplated implementation, which is not intended to be exhaustive. For example, an auto case correction feature can be implemented in a different embodiment that automatically detects and replaces words/phrases believed to have improper case. Any auto case correction feature can consider recent key presses including presses of the caps lock key when determining whether an automatic case correction is to be applied. In another contemplated implementation, an auto case correction feature can automatically toggle a caps lock feature when it determines that it is in an incorrect state. As previously indicated, user selectable settings (e.g., settings 118) can be established to control case related behavior applied to GUI 200.

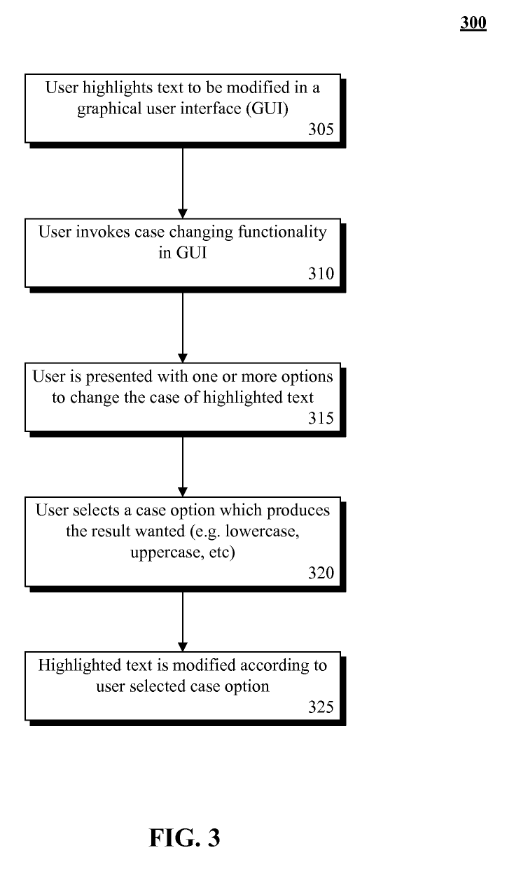

FIG. 3 is a schematic diagram illustrating a method 300 for enabling a user to change the letter case of highlighted text in accordance with an embodiment of the inventive arrangements disclosed herein. Method 300 can be performed in the context of system 100. In method 300, a user interacting with a graphical user interface (GUI) can rapidly modify the letter case of one or more words. In step 305, a user highlights text to be modified. In step 310, the user can invoke case changing functionality via menu entries in a drop down menu, by selecting functionality from a toolbar, or pressing a hot-key. In step 315, a user is presented with one or more options to change the case of highlighted text. Options can be presented in a pop-up dialog box or GUI window. Options can include uppercase, lowercase, sentence case, title case, invert case, random case, and the like. Selection can be presented in the form of a drop down selection, toggle button, slider button, and the like. In step 320, the user selects a case option which produces the result desired. In step 325, the highlighted text is modified by a case converter according to the user selected case option.

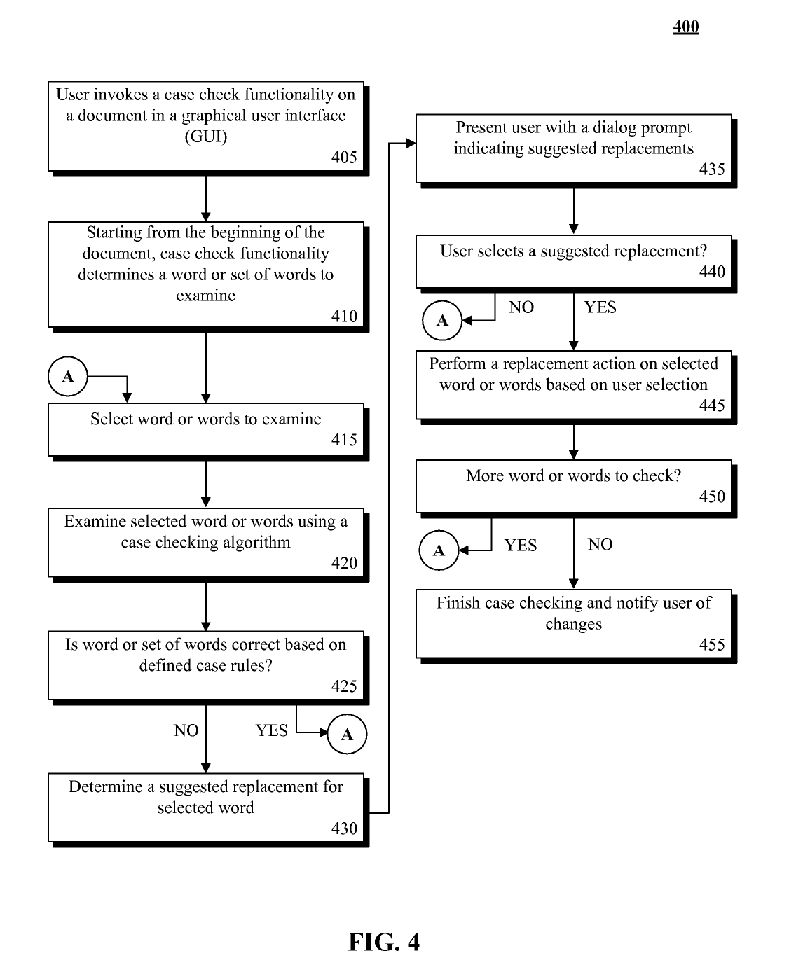

FIG. 4 is a schematic diagram illustrating a method 400 for checking the letter case of electronic document content in response to a user invocation in accordance with an embodiment of the inventive arrangements disclosed herein. Method 400 can be performed in the context of system 100. In method 400, a user can perform a letter case check on an electronic document and automatically correct or modify the letter case of one or more words in the document.

In step 405, a user can invoke case check functionality on a document in a graphical user interface (GUI). Invocation can occur through pull down menus, context menus, toolbar selections, and the like. In step 410, case check functionality can start from the beginning of the document or current cursor position and determine a word or set of words to examine. In step 415, a word or set of words is selected to be examined by a case analysis software component. In step 420, the selected word or words is examined using a case checking algorithm to determine if a change is necessary. Using common language rules, appropriate letter case can be determined for each word or set of words based on context. For example, in the English language the first letter of proper nouns are capitalized, where in other languages proper nouns are lower cased.

In step 425, if the selected word or words are suitable based on defined letter case rules, method can return to step 425, else proceed to step 430. In step 430, a suggested replacement or list of replacements is determined. In step 435, a user is presented with a dialog prompt indicating suggested replacements. In step 440, if the user selects a suggested replacement the method can proceed to step 445, else return to step 415. In step 445, a replacement action is performed on the selected word or words based on the user selection. In step 450, if there are more word or words to case check the method can return to step 415, else proceed to step 455. In step 455, the case checking operation can terminate and notify the user of changes made. Notification can include presenting the number modifications in a status bar, highlighting/underlining changed word or words, and the like.

The present invention may be realized in hardware, software, or a combination of hardware and software. The present invention may be realized in a centralized fashion in one computer system, or in a distributed fashion where different elements are spread across several interconnected computer systems. Any kind of computer system or other apparatus adapted for carrying out the methods described herein is suited. A typical combination of hardware and software may be a general purpose computer system with a computer program that, when being loaded and executed, controls the computer system such that it carries out the methods described herein.

The present invention also may be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

This invention may be embodied in other forms without departing from the spirit or essential attributes thereof. Accordingly, reference should be made to the following claims, rather than to the foregoing specification, as indicating the scope of the invention.

What is claimed is:

1. Software for providing case manipulation enhancements comprising:
a case converter configured to identify user selected text, to receive a user selected case command, and to apply the case command to the user selected text, which results in the selected text being replaced with replacement text, said replacement text corresponding to the user selected text that has been case changed in accordance with the case command, wherein said case converter is software digitally encoded in a computer readable medium executable by a computing device, which causes the computing device to perform a set of actions for which the case converter is configured.

2. The software of claim 1, wherein case commands available for the case converter to apply comprise an upper case command, a lower case command, and a toggle case command, wherein applying the upper case command results in letters in the replacement text being converted to upper case, wherein applying the lower case command results in letters in the replacement text being converted to lower case, wherein applying the toggle case command results in each lower case letter of the user selected text being converted to its upper case letter equivalent in the replacement text and each upper case letter of the user selected text being converted to its lower case equivalent in the replacement text.

3. The software of claim 1, wherein case commands available for the case converter to apply comprise a sentence case command, a title case command, and a random case command, wherein applying the sentence case command results in letters in the replacement text being converted to upper case and lower case based upon sentence structure and grammar rules for capitalizing a first letter of a sentence, for capitalizing proper nouns, for capitalizing acronyms, and for otherwise using lower case, wherein applying the title case command results in a first letter of a word being capitalized and each subsequent letter of a word being converted to lower cased within the replacement text, and wherein applying the random case command results in a randomized assignment of upper and lower case to letters within the replacement text.

4. The software of claim 1, further comprising:
a text editing interface configured to permit a user to provide input, which defines the user selected text, and configured to permit a user to select among a plurality of possible commands, wherein a user selected one of the possible commands is the applied case command.

5. The software of claim 4, wherein said text editing interface is a Graphical User Interface (GUI), and wherein said input which defines the user selected text is a mouse input that causes the user selected text to be highlighted within the GUI.

6. The software of claim 5, wherein said text editing interface comprises a pop-up menu that includes items for each of said plurality of possible commands, wherein the user selected one of the possible commands is a command selected by a user from the pop-up menu.

7. The software of claim 1, further comprising:
a case analyzer configured to apply a set of programmatic rules to a text segment, to automatically determine from the set of rules whether letters included in the text segment have a proper case, and to present results from applying the set of rules to a user, wherein the results indicate those letters that are determined to have an improper case, wherein said case converter is software digitally encoded in a computer readable medium executable by a computing device, which causes the computing device to perform a set of actions for which the case analyzer is configured.

8. The software of claim 1, wherein said text segment is a user selected segment highlighted within a Graphical User Interface (GUI).

9. The software of claim 1, wherein said text segment is an electronic document in its entirety.

10. The software of claim 7, wherein said case analyzer is further configured to suggest textual replacements having a proper case for each indicated set of letters that are determined to have an improper case.

11. The software of claim 7, wherein case checking actions of the case analyzer are performed automatically against the text segment when a user performs a spell checking operation against the text segment.

12. The software of claim 7, wherein the case analyzer and the case converter are configured to provide case related functions for a plurality of different applications.

13. An interactive method for altering case of a text segment comprising:
receiving a user selection of a text segment within a user interface, said user interface comprising at least one of a Graphical User Interface (GUI) and a Voice User Interface (VUI);
receiving a user input via the user interface that indicates a case command to be performed against the text segment, wherein said case command is a command selected from a group of commands comprising an upper case command, a lower case command, a toggle case command, a sentence case command, a title case command, and a random case command;
applying the case command to the text segment to change the text segment in accordance with the case command; and
presenting the changed text segment to a user via the user interface.

14. The method of claim 13, further comprising:
when the user selection is made in a Graphical User Interface (GUI), visually highlighting the user selected text segment; and
when the user selection is made in the Voice User Interface (VUI), audibly confirming the user selected text segment.

15. The method of claim 13, wherein said user interface is a Graphical User Interface, wherein said input which defines the user selected text is a mouse input, said method further comprising:
visually highlighting the user selected text segment; and
presenting a pop-up menu that includes items for each of a plurality of possible commands, wherein the applied case command is a user selected one of the possible commands.

16. The method of claim 13, further comprising:
permitting a user to select the case command from a defined set of possible commands, wherein said defined set of possible commands comprises the upper case command, the lower case command, the toggle case command, the sentence case command, the title case command, and the random case command, wherein applying the upper case command results in letters in the replacement text being converted to upper case, wherein applying the lower case command results in letters in the replacement text being converted to lower case, wherein applying the toggle case command results in each lower case letter of the user selected text being converted to its upper case letter equivalent in the replacement text and each upper case letter of the user selected text being converted to its lower case equivalent in the replacement text, wherein applying the sentence case command results in letters in the replacement text being converted to upper case and lower case based upon sentence structure and grammar rules for capitalizing a first letter of a sentence, for capitalizing proper nouns, for capitalizing acronyms, and for otherwise using lower case, wherein applying the title case command results in a first letter of a word being capitalized and each subsequent letter of a word being converted to lower cased within the replacement text, and wherein applying the random case command results in a randomized assignment of upper and lower case to letters within the replacement text.

17. The method of claim 13, further comprising:
receiving a user command to analyze at least a portion of an electronic document for case related errors;
analyzing said at least a portion of the electronic document to detect the text segment as containing at least one case related error, wherein said detection is based upon a set of previously configured programmatic rules; and
presenting through the user interface the detected text segment, wherein the receiving of the user selection occurs after the presenting of the detected text segment.

18. A method for conducting a case check comprising:
receiving from a user interface a user command to analyze at least a portion of an electronic document for case related errors, said user interface comprising at least one of a Graphical User Interface (GUI) and a Voice User Interface (VUI);
apply a set of programmatic rules to the portion;
automatically determining from the set of rules whether letters included in the portion of the electronic document have a proper case; and
presenting results from applying the set of rules within the user interface, wherein the results indicate those letters that are determined to have an improper case.

19. The method of claim 18, further comprising:
determining a suggested replacement for each set of letters determined to have an improper case; and
presenting the determined suggested replacement within the user interface.

20. The method of claim 18, further comprising:
proximate to at least a portion of the presented results that indicates a set of letters determined to have an improper case, presenting a user with a set of possible case commands;
receiving a user selection of one of the presented case commands;
applying the case command to the set of letters to change the set of letters in accordance with the case command; and
presenting the changed set of letters to a user via the user interface.
